(19) United States
(12) Patent Application Publication
(10) Pub. No.: US 2004/0227091 A1
(43) Pub. Date: Nov. 18, 2004

(54) Methods and apparatus for radiation detecting and imaging using monolithic detectors

(76) Inventors: James Walter LeBlanc, Niskayuna, NY (US); Floribertus Heukensfeldt Jansen, Ballston Lake, NY (US); Richard Allen Thompson, Schenectady, NY (US)

Correspondence Address: John S. Beulick, Armstrong Teasdale LLP, Suite 2600, One Metropolitan Sq., St. Louis, MO, 63102, US

(21) Appl. No.: 10/437,473

(22) Filed: May 14, 2003

(51) Int. Cl. G01T 1/20

(52) U.S. Cl. 250/366

(57) ABSTRACT

A method for detecting radiation using a monolithic detector is provided. The method includes providing a monolithic scintillator to interact with incident radiation and to generate a photon at a site of interaction, optically coupling a plurality of photosensors to the monolithic scintillator to detect the photon generated at the site of interaction, and configuring each photosensor to transmit a signal indicative of an amount of light detected by each photosensor and a solid angle covered by the photosensor relative to the site of interaction.

### BACKGROUND OF THE INVENTION

This invention relates generally to detection and imaging systems, and more specifically to methods and apparatus for detecting and imaging radiation using monolithic detectors.

In nuclear medicine, images of internal structures or functions of a patient's body are generated by using an imaging system to detect radiation emitted from within the body after the patient has been injected with a radiopharmaceutical substance. The imaging system typically uses one or more scintillator-based detectors to detect the radiation. A computer system generally controls the detectors to acquire data and then processes the acquired data to generate the images. Nuclear medicine imaging techniques include Single-Photon Emission Computed Tomography (SPECT) and Positron Emission Tomography (PET). SPECT imaging is based on the detection of individual gamma rays emitted from the body, while PET imaging is based on the detection of gamma ray pairs that are emitted in coincidence in opposite directions due to electron-positron annihilations. PET imaging is therefore often referred to as “coincidence” imaging. At least some known nuclear medicine imaging systems use a small number, for example two, of monolithic or continuous scintillation crystal based detectors. Other known systems use detectors that consist of a grid of many scintillation crystals, sometimes referred to as “block detectors”, as with many dedicated PET systems.

One factor that can affect higher resolution and larger coverage image quality in nuclear medicine imaging systems is optical segmentation of the scintillator block, particularly since a large volume scintillator necessitates cost-effective manufacturing processes. PET scintillation detectors typically use some degree of pixellation or segmentation in order to sufficiently control the optical photon propagation pattern such that 2D-position resolution can be achieved. Known PET detector blocks with segmented crystals may be inherently limited in resolution to the size of the crystal, which for human clinical scanners is typically 4-8 mm. To achieve 3D resolution, some known PET detectors detect the gamma interaction scintillation light on both the gamma ray entrance and exit sides; while this technique may potentially lead to 3D resolution, these detectors still utilize segmented scintillator crystals and therefore, their resolution is limited by the ability to manufacture a block of small scintillator crystals cost effectively.

### BRIEF DESCRIPTION OF THE INVENTION

In one aspect, a method for detecting and imaging radiation using a monolithic detector is provided. The method includes providing a monolithic scintillator to interact with incident radiation and to generate a photon at a site of interaction, optically coupling a plurality of photosensors to the monolithic scintillator to detect the photon generated at the site of interaction, and configuring each photosensor to transmit a signal indicative of an amount of light detected by each photosensor and a solid angle covered by the photosensor relative to the site of interaction.

In another aspect, a radiation detector for detecting and imaging incident radiation by a scintillation event that occurs at a site of interaction is provided. The detector includes a monolithic scintillator that includes a plurality of surfaces wherein the scintillator generates at least one photon for each radiation interaction, and a plurality of photosensors optically coupled to at least one surface for determining the site of interaction in three-dimensions.

### BRIEF DESCRIPTION OF THE DRAWINGS

FIG. 1 is a perspective view of an exemplary positron emission tomography system;

FIG. 2 is a partially exploded view of an exemplary detector that may be used with the system shown in FIG. 1;

FIG. 3 illustrates an exemplary detector that includes a single monolithic scintillator crystal optically coupled to a single photosensor;

FIG. 4 illustrates another exemplary embodiment of a detector that includes a single monolithic scintillator crystal optically coupled to two opposing photosensors.

FIG. 5 illustrates an exemplary embodiment of a detector that includes a single monolithic scintillator crystal optically coupled to two opposing photosensors and to a third photosensor, each photosensor optically coupled to a surface of crystal that extends between the two opposing photosensors;

FIG. 6 illustrates an alternative exemplary embodiment of detector that includes a single monolithic scintillator crystal optically coupled to three photosensors that are adjacent with respect to each other; and

FIG. 7 is an illustration of an exemplary scintillation event in the detector shown in FIG. 6.

### DETAILED DESCRIPTION OF THE INVENTION

Positrons are beta (β⁺) particles, which are emitted in the decay of certain radionuclides that may have been prepared using a cyclotron or other device. The radionuclides most often employed in diagnostic imaging are fluorine-18 (¹⁸F), carbon-11 (¹¹C), nitrogen-13 (¹³N), and oxygen-15 (¹⁵O). Radionuclides are employed as radioactive tracers called “radiopharmaceuticals” by incorporating them into substances such as fluorodeoxyglucose (FDG) or carbon dioxide. One common use for radiopharmaceuticals is in the medical imaging field.

During an imaging procedure, the radiopharmaceutical may be injected into a patient, where it accumulates in an organ, vessel or other body part of interest, which is to be imaged. It is known that specific radiopharmaceuticals become concentrated within certain organs or, in the case of a vessel, that specific radiopharmaceuticals will not be absorbed by a vessel wall. The process of concentrating often involves processes such as glucose metabolism, fatty acid metabolism and protein synthesis. Hereinafter, in the interest of simplifying this explanation, an organ to be imaged including a vessel will be referred to generally as an “organ of interest” and the invention will be described with respect to a hypothetical organ of interest.

After the radiopharmaceutical becomes concentrated within an organ of interest and while the radionuclides decay, the radionuclides emit positrons. The positrons travel a very short distance before they encounter an electron and, when the positron encounters an electron, the positron is annihilated and converted into two photons, or gamma rays. This annihilation event is characterized by two features which are pertinent to medical imaging and particularly to medical imaging using photon emission tomography (PET). First, each gamma ray has an energy of approximately 511 keV upon annihilation. Second, the two gamma rays are directed in substantially opposite directions.

In PET imaging, if the locations of annihilations can be identified in three dimensions, a three dimensional image of radiopharmaceutical concentration in an organ of interest can be reconstructed for observation. To detect annihilation locations, a PET camera is employed. An exemplary PET camera includes a plurality of detectors and a processor which, includes coincidence detection circuitry.

The coincidence circuitry identifies essentially simultaneous pulse pairs which correspond to detectors which are essentially on opposite sides of the imaging area. A simultaneous pulse pair indicates that an annihilation has occurred on a straight line between an associated pair of detectors. Over an acquisition period of a few minutes millions of annihilations are recorded, each annihilation associated with a unique detector pair. After an acquisition period, recorded annihilation data may be used to reconstruct a three dimensional image of the organ of interest.

As used herein, an element or step recited in the singular and preceded with the word “a” or “an” should be understood as not excluding the plural elements or steps, unless such exclusion is explicitly recited. Furthermore, references to “one embodiment” of the present invention are not intended to be interpreted as excluding the existence of additional embodiments that also incorporate the recited features.

Also as used herein, the phrase “reconstructing an image” is not intended to exclude embodiments in which data representing an image is generated but a viewable image is not. Therefore, as used herein the term “image” broadly refers to both viewable images, data representing a viewable image, and data that may be used to make inferences about the distribution of radionuclides in a form that cannot be converted into a viewable image. However, many embodiments generate (or are configured to generate) at least one viewable image.

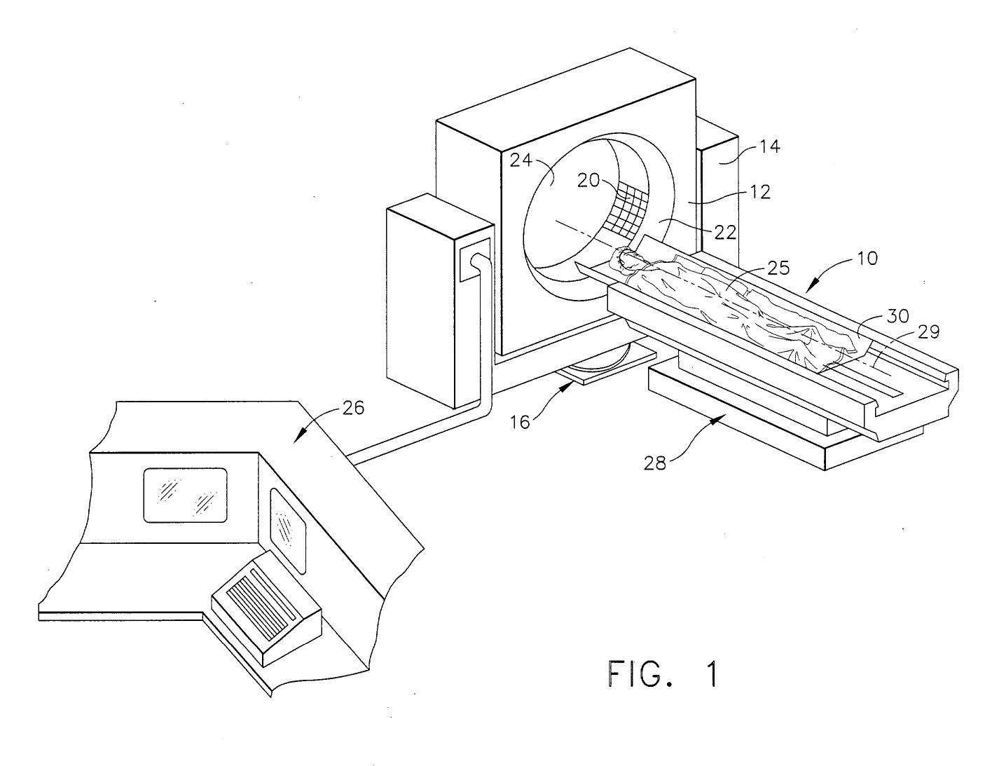

FIG. 1 is a perspective view of an exemplary positron emission tomography system 10. System 10 includes a gantry 12 coupled to a U-shaped mounting bracket 14 supported on a base 16. A plurality of detectors 20 for diagnostic imaging operations are positioned in a cylindrical array on a ring 22, with the faces of the detectors 20 defining a cylindrical opening 24 for receiving a predetermined portion of a patient's body 25. Signal outputs from the detectors 20 are transmitted to a monitoring station 26 for analysis and display. Station 26 includes a computer for processing the transmitted signals to produce tomographic images of the patient within the field of view of the plurality of detectors 20. System 10 includes a patient bed 28, which includes a sliding carriage 30, for moving a selected body portion of a patient 25 into and out of opening 24. During a scan, patient 25 may be located on a central axis 29 of the cylindrical array of detectors 20. This geometric arrangement is such that the positron radiation from within patient 25 may impinge upon the plurality of detectors 20 for generating PET scan data.

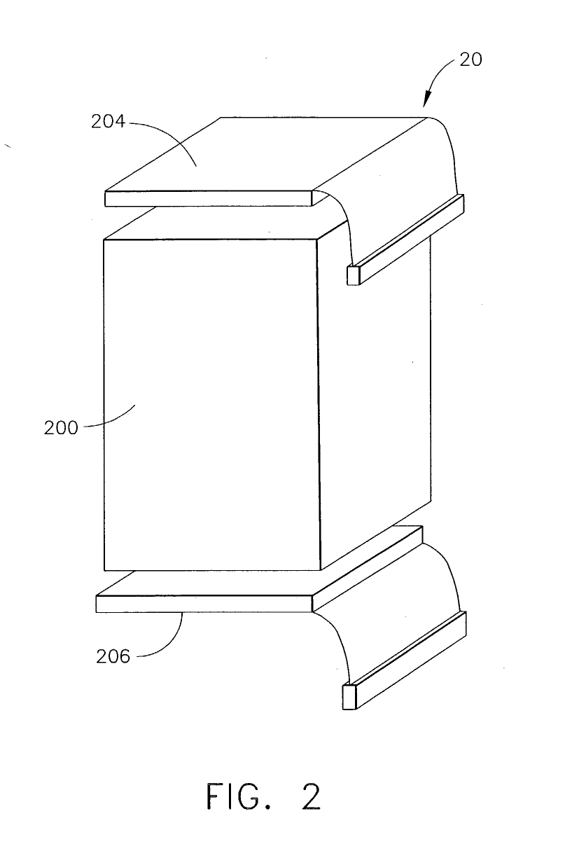

FIG. 2 is a partially exploded view of detector 20 that may be used with system 10 (shown in FIG. 1). In the exemplary embodiment, detector 20 includes a monolithic scintillator crystal 200. As used herein, monolithic means the scintillator detector is not physically segmented, is formed of a substantially single scintillator material throughout the crystal, and exhibits substantially uniform optical transport characteristics through the entire crystal volume. A first photosensor 204 is optically coupled to a first surface of scintillator 200. A second photosensor 206 is optically coupled to a second surface of scintillator 200. In the exemplary embodiment, photosensor 204 is a position sensitive avalanche photodiode (PSAPD). In an alternative embodiment, photosensor 204 is a position sensitive avalanche photodiode (PSAPD). In another alternative embodiment, photosensor 204 is a non-position sensitive avalanche photodiode. In yet another alternative embodiment, photosensor 204 is a non-position sensitive photodiode. In other alternative embodiments, photosensors 204 may include both position sensitive and non-position sensitive photosensor types. In further alternative embodiments, photosensors 204 may be optically coupled to one of any number of sides of scintillator 200 such that photons from each radiation interaction may be detected by at least one photosensor 204, if it is not absorbed by the scintillator material or at the scintillator surface.

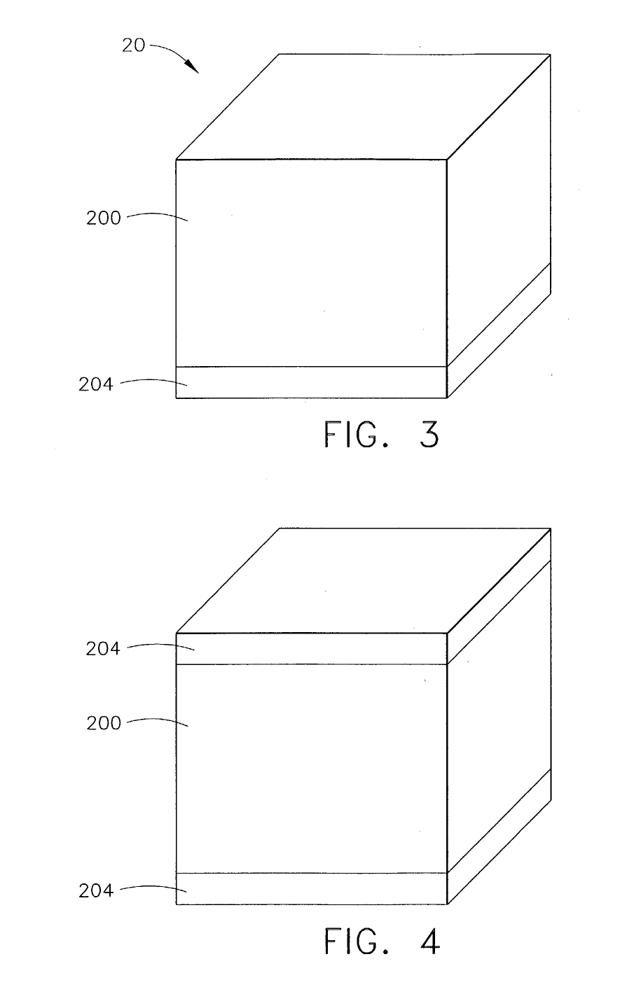

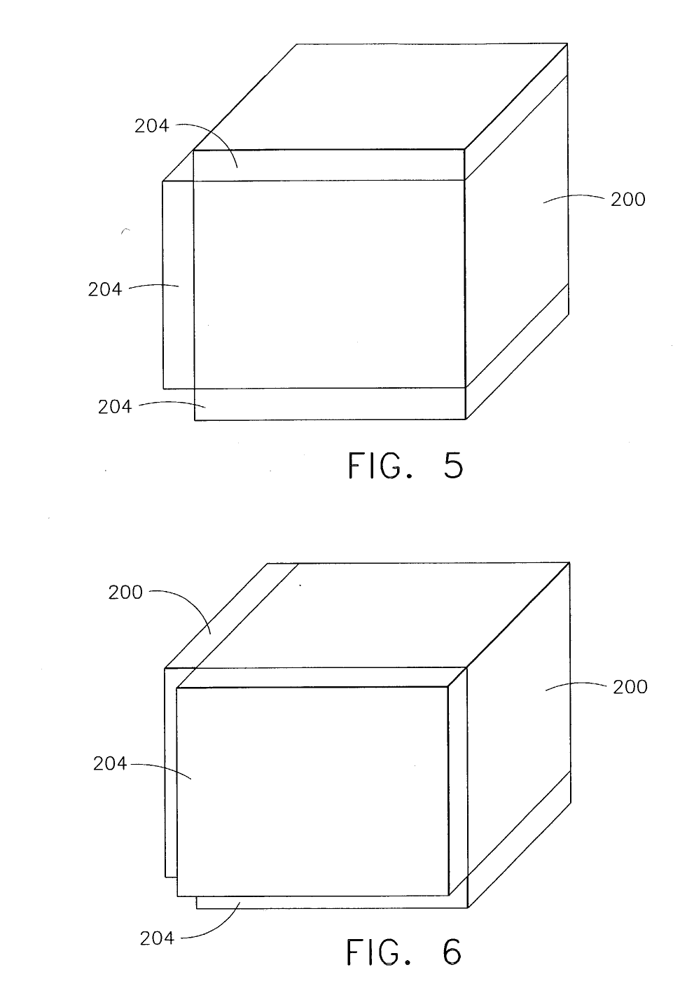

FIGS. 3-6 are schematic views of a plurality of exemplary embodiments of a monolithic scintillator detector 20 that may be used with system 10 (shown in FIG. 1). FIG. 3 illustrates detector 20 that, in one embodiment, includes a single monolithic scintillator crystal 200 optically coupled to a single photosensor 204. FIG. 4 illustrates another exemplary embodiment of detector 20 that includes a single monolithic scintillator crystal 200 optically coupled to two opposing photosensors 204. In alternative embodiment, photosensors 204 are optically coupled to adjacent surfaces of crystal 200. FIG. 5 illustrates an exemplary embodiment of detector 20 that includes a single monolithic scintillator crystal 200 optically coupled to two opposing photosensors 204 and a third photosensor 204 optically coupled to a surface of crystal 200 that extends between the two opposing photosensors 204. FIG. 6 illustrates an alternative exemplary embodiment of detector 20 that includes a single monolithic scintillator crystal 200 optically coupled to three photosensors 204 that are adjacent with respect to each other. In other alternate embodiments, additional surfaces of crystal 200 are optically coupled to photosensors, such as, but, not limited to four, five, six, or more surfaces. Additionally, crystal 200 is illustrated as substantially cubic-shaped by way of example only, and it should be understood that crystal 200 may include any number of surfaces, of which, any number of the surfaces may be coupled to photosensors.

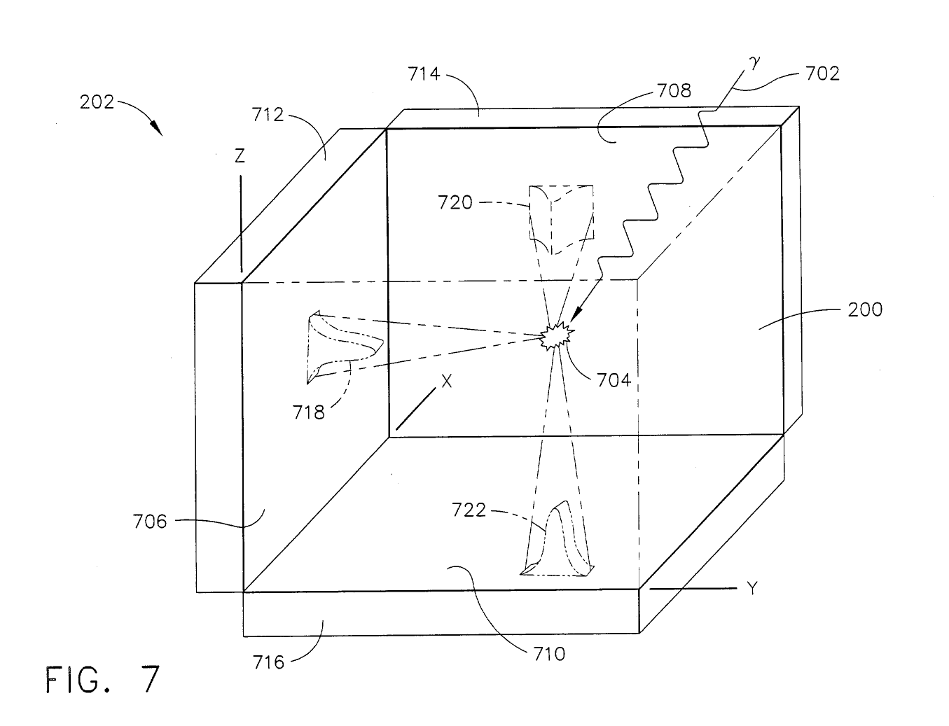

FIG. 7 is an illustration of an exemplary scintillation event 700 in detector 200. An incoming gamma 702 enters crystal 200 through one of a plurality of surfaces of crystal 200. Gamma 702 may originate from a positron-electron annihilation in a PET imaging system, may originate from an x-ray source in a CT imaging system, may originate from a radiopharmaceutical in a gamma camera system, or may be the result of radioactive decay from other sources. Gamma 702 interacts with the scintillator material generating one or more photons that are emitted from a site of interaction 704. Each photon then propagates through the scintillator material where the photon may be scattered or completely absorbed. Each photon that reaches an outer surface, such as, a surface 706, a surface 708, and/or a surface 710 of crystal 200 may impinge on one of a plurality photosensors optically coupled to surfaces 706, 708, and 710, such as photosensors 712, 714, and 716 respectively. In the exemplary embodiment, each photosensor is a position sensitive APD 204. In an alternative embodiment, the photosensors are non-position sensitive photosensors. The photons impinging on photosensors 712, 714, and 716 generate a signal in each photosensor 712, 714, and 716 that is proportional to the intensity of the impinging photons and are represented by respective peaks 718, 722, and 722. The intensity of the photon flux impinging each detector is represented as a relative height of each respective peak 718, 722, and 722 and is related to the location of the site of interaction where it was generated and the bulk and surface optical transport properties of the scintillator material.

The three dimensional point of gamma ray interaction is determined from the relative signals on photosensors 712, 714, and 716 coupled to surfaces 706, 708, and 710, respectively. The probability that a photon from an interaction event reaches photosensors 712, 714, and 716 is governed by two basic phenomena, namely: the attenuation (absorption and scatter) of light in the bulk of each crystal, or the escape or absorption of light in interactions with the surfaces of the ends or side walls of crystal 200. An amount of light collected by each photosensor 712, 714, and 716 determines a magnitude of an electrical signal generated by that photosensor, and is sensitive to a solid angle covered by that photosensor relative to site of interaction 704 and the optical transport properties of the scintillator material. If site of interaction 704 occurred closer to photosensor 712, the signal generated by photosensor 712 would increase and the signal on photosensors 714 and 716 would decrease. In other embodiments, this solid angle sensitivity is exploited with non-position sensitive photosensors covering 3-6 sides of scintillator 200 by triangulating site of interaction 704 based on a response of the photosensors without any crystal segmentation. In other embodiments, position sensitive photosensors are implemented in detector 20. Additional information provided by position sensitive photosensors is used to facilitate improving the hit reconstruction resolution and/or to facilitate reducing the number of sides of scintillator 200 that are optically coupled to photosensors. In other embodiments, the optical transport properties of the surfaces and of the bulk scintillator are exploited along with the solid angle sensitivity to facilitate improving and/or optimizing the interaction locations and/or to facilitate reducing the number of sides of scintillator 200 that are optically coupled to photosensors.

Although the above-described monolithic detector was discussed with respect to a PET imaging system, the detector may be to applications other than PET that rely on scintillator blocks, such as, but not limited to, nuclear medicine, hand held imaging probes, CT detectors, bone mineral densitometry, and others.

The above-described monolithic detector is a cost-effective and highly reliable means for detecting and imaging radiation using monolithic detectors while providing a simpler block design without the need for dicing and polishing individual crystals. More specifically, the methods and apparatus described herein facilitate allowing the scintillator block to remain unsegmented leading to cost savings and enabling higher resolution detectors. In addition, the above-described methods and apparatus facilitate allowing novel scintillator fabrication techniques that inherently shape the light spreading function and optimization of scintillator optical transport and surface properties without the need for physical segmentation of the scintillator, and enable use of scintillators that are currently not believed capable of meeting the PET performance requirements. As a result, the methods and apparatus described herein facilitate reducing nuclear imaging system fabrication and material costs in a cost-effective and reliable manner.

While the invention has been described in terms of various specific embodiments, those skilled in the art will recognize that the invention can be practiced with modification within the spirit and scope of the claims.

What is claimed is:

1. A method for detecting and imaging radiation using a monolithic detector, said method comprising:
providing a monolithic scintillator to interact with incident radiation and to generate a photon at a site of interaction;
optically coupling a plurality of photosensors to the monolithic scintillator to detect the photon generated at the site of interaction; and
configuring each photosensor to transmit a signal indicative of an amount of light detected by each photosensor and a solid angle covered by the photosensor relative to the site of interaction.

2. A method in accordance with claim 1 wherein providing a monolithic scintillator to interact with incident radiation comprises providing a monolithic scintillator to interact with radiation from a radiopharmaceutical within a patient of interest.

3. A method in accordance with claim 1 wherein providing a monolithic scintillator to interact with incident radiation comprises providing a monolithic scintillator that includes a body having a plurality of substantially planar boundaries.

4. A method in accordance with claim 1 wherein providing a monolithic scintillator to interact with incident radiation comprises providing a monolithic scintillator that is substantially cubic.

5. A method in accordance with claim 1 wherein optically coupling a plurality of photosensors to the monolithic scintillator comprises optically coupling a plurality of position sensitive photosensors to the monolithic scintillator.

6. A method in accordance with claim 1 wherein optically coupling a plurality of photosensors to the monolithic scintillator comprises optically coupling a plurality of non-position sensitive photosensors to the monolithic scintillator.

7. A method in accordance with claim 1 wherein optically coupling a plurality of photosensors to the monolithic scintillator comprises optically coupling a photosensor to each of two adjacent surfaces of the monolithic scintillator.

8. A method in accordance with claim 1 wherein optically coupling a plurality of photosensors to the monolithic scintillator comprises optically coupling a photosensor to each of two opposing surfaces of the monolithic scintillator.

9. A method in accordance with claim 1 wherein optically coupling a plurality of photosensors to the monolithic scintillator comprises optically coupling a photosensor to each of three adjacent surfaces of the monolithic scintillator.

10. A method in accordance with claim 1 wherein optically coupling a plurality of photosensors to the monolithic scintillator comprises optically coupling a photosensor to each of at least one of three of the surfaces, four of the surfaces, five of the surfaces, and six of the surfaces are each optically coupled to a respective photosensor.

11. A method in accordance with claim 1 further comprising determining a position of the site of interaction using the plurality of transmitted signals.

12. A method in accordance with claim 11 wherein the site of interaction is represented in three-dimensions by a coordinate system, said method further comprising determining a weighted ratio of the received signals in an x-direction, a y-direction and a z-direction to determine the site of interaction in three-dimensions.

13. A method in accordance with claim 11 wherein the site of interaction is represented in three-dimensions by a coordinate system, said method further comprising:
measuring an x-direction component, a y-direction component and a z-direction component of the received signals; and
determining the site of interaction in three-dimensions using triangulation.

14. A method in accordance with claim 11 wherein determining a position of the site of interaction further comprises using at least one of a look-up table and a transfer function.

15. A method for detecting and imaging radiation from a radiopharmaceutical within a patient of interest using a monolithic position sensitive detector that includes a body having a plurality of substantially planar boundaries, said method comprising:
receiving radiation using a monolithic scintillator to interact with the radiation and to generate a light at a site of interaction;
receiving light from the scintillator using a plurality of photosensors, each photosensor optically coupled to a surface of the scintillator to detect the light generated at the site of interaction;
transmitting a signal indicative of an amount of light detected by each photosensor and a solid angle covered by the photosensor relative to the site of interaction; and
determining a position of the site of interaction using the transmitted signal using at least one of a look-up table and a transfer function.

16. A method in accordance with claim 15 wherein receiving radiation using a monolithic scintillator comprises receiving radiation using a monolithic scintillator that is substantially cubic.

17. A method in accordance with claim 15 wherein receiving light from the scintillator using a plurality of photosensors comprises receiving light from the scintillator using a plurality of position sensitive photosensors.

18. A method in accordance with claim 15 wherein receiving light from the scintillator using a plurality of photosensors comprises receiving light from the scintillator using a plurality of non-position sensitive photosensors.

19. A method in accordance with claim 15 wherein receiving light from the scintillator using a plurality of photosensors comprises receiving light from the scintillator using a plurality of photosensors that are optically coupled to each surface of the scintillator.

20. A method in accordance with claim 15 wherein the site of interaction is represented in three-dimensions by a coordinate system, said method further comprising determining a weighted ratio of the received signals in an x-direction, a y-direction and a z-direction to determine the site of interaction in three-dimensions.

21. A method in accordance with claim 15 wherein the site of interaction is represented in three-dimensions by a coordinate system, said method further comprising:
measuring an x-direction component, a y-direction component and a z-direction component of the received signals; and
determining the site of interaction in three-dimensions using triangulation.

22. A radiation detector for detecting incident radiation by a scintillation event that occurs at a site of interaction, said detector comprising:
a monolithic scintillator comprising a plurality of surfaces, said scintillator generates at least one photon for each radiation interaction; and
a plurality of photosensors, each photosensor optically coupled to a respective said surface for determining the site of interaction in three-dimensions.

23. A detector in accordance with claim 22 wherein said scintillator comprises a body formed from a scintillator material, said body having a plurality of substantially planar surfaces.

24. A detector in accordance with claim 23 wherein a plurality of said planar surfaces are each optically coupled to a respective photosensor.

25. A detector in accordance with claim 23 wherein said plurality of photosensors are non-position sensitive.

26. A detector in accordance with claim 24 wherein said photosensor comprises an avalanche photo-diode (APD).

27. A detector in accordance with claim 26 wherein said APD is a position-sensitive APD (PSAPD).

28. A detector in accordance with claim 23 wherein two adjacent said surfaces are each optically coupled to a respective photosensor.

29. A detector in accordance with claim 23 wherein two opposing said surfaces are each optically coupled to a respective photosensor.

30. A detector in accordance with claim 23 wherein at least one of three said surfaces, four said surfaces, five said surfaces, and six said surfaces are each optically coupled to a respective photosensor.

31. A detector in accordance with claim 23 wherein three adjacent said surfaces are each optically coupled to a respective photosensor.

32. A detector in accordance with claim 22 wherein each of the plurality of scintillator surfaces is optically coupled to a respective photosensor.
